(19) United States
(12) Patent Application Publication
(10) Pub. No.: US 2026/0099674 A1
(43) Pub. Date: Apr. 9, 2026

(54) AUTOMATED PIPELINE FOR TRAINING LANGUAGE MODELS

(71) Applicant: U.S. Bank National Association, Minneapolis, MN (US)

(72) Inventors: Giacomo Domeniconi, Queens, NY (US); Ali Fathi, San Francisco, CA (US); Samuel A. Assefa, Watertown, MA (US); Kausik Gangopadhyay, Mount Holly, NC (US); Christopher Taggert, Charlotte, NC (US); Samuel Atkins, Vancouver (CA)

(73) Assignee: U.S. Bank National Association, Minneapolis, MN (US)

(21) Appl. No.: 18/909,206

(22) Filed: Oct. 8, 2024

(51) Int. Cl. G06F 40/295; G06F 40/284; G06F 40/40; G06N 3/0475; G06N 3/094

(52) U.S. Cl. CPC G06F 40/295; G06F 40/284; G06F 40/40; G06N 3/0475; G06N 3/094

(57) ABSTRACT

The disclosed embodiments describe a method, system, and computer-readable medium for generating a training dataset for training a model in the field of natural language processing involving receiving a set of input samples and performing a rephrasing operation to produce new versions of the set of input samples, where the new versions preserve semantic equivalence as the set of input samples but have different phrasing. A dataset of generated versions of the input samples is generated using a generative Language Learning Model (LLM), all entity references present in the generated versions of the input samples are labeled, and the generated versions of the input samples and their corresponding labeled versions to form an expanded labeled dataset are aggregated.

### TECHNICAL FIELD

Example embodiments described herein relate generally to natural language processing, and more particularly to an automated pipeline for creating a synthetic set of input samples to train models that convert textual input to structured formats for downstream tasks.

### BACKGROUND

Text-to-structured tasks (also referred to as “functional representations”) involve converting unstructured textual data into a structured format. The structured format can vary depending on the specific task and the desired output. The goal is to extract relevant information from the text and represent it in a structured manner that is more easily processed and analyzed, such as by software or machines.

This structured format can vary depending on the specific task and desired output. Examples of text-to-structured tasks include converting text into tabular form, where each column represents a specific attribute, and each row represents an instance or record. Another example is transforming text into a graph structure, where entities and relationships mentioned in the text are represented as nodes and edges. Text-to-structured tasks can also involve converting text into formats like JavaScript Object Notation (JSON), extensible Markup Language (XML), or YAML Ain′t Markup Language (YAML), which provide a hierarchical representation of the extracted information. Overall, these tasks are aimed at extracting and organizing information from unstructured text, for structured data interchange and configuration purposes, and enabling easier integration, analysis, and further processing of the data.

Training models for text-to-structured tasks presents several technical challenges. Limited availability of labeled training data for specific tasks can hinder the model's ability to generalize to new examples. Moreover, even when data is available, ensuring its quality and proper labeling is difficult, time-consuming, and expensive, especially when expertise and manual effort are required. Expert labeling is also prone to errors. Further, the variability in text and structure poses additional challenges. Texts can vary in length, style, and language, making it hard for models to accurately extract structured information. Similarly, structured formats can differ in complexity and organization, complicating the learning of consistent mappings. Models trained on one domain may struggle to generalize to new domains, necessitating additional labeled data and fine-tuning. Handling ambiguity and noise in texts is crucial, as they can contain unclear or misleading information. Models need to be robust enough to manage such cases and make informed decisions. Additionally, addressing biases in the labeled data and ensuring fairness in text-to-structured models is an ongoing challenge.

Overcoming these challenges involves techniques like data preprocessing, domain-specific feature engineering, model architecture modifications, and continuous evaluation and improvement of the training process.

### SUMMARY

In a first aspect, a method for generating a training dataset for training a model, is provided. The method includes performing receiving a set of input samples. The method further includes performing a rephrasing operation to produce new versions of the set of input samples, wherein the new versions preserve semantic equivalence as the set of input samples but have different phrasing. The method also includes generating a dataset of generated versions of the input samples using a generative Language Learning Model (LLM), labeling all entity references present in the generated versions of the input samples, and aggregating the generated versions of the input samples and their corresponding labeled versions to form an expanded labeled dataset.

In a second aspect, a system for generating a training dataset for training a model, is provided. The system includes a processor and a memory operatively connected to the processor and storing instructions which, when executed by the processor, cause the system to perform: receiving a set of input samples; performing a rephrasing operation to produce new versions of the set of input samples, wherein the new versions preserve semantic equivalence as the set of input samples but have different phrasing; generating a dataset of generated versions of the input samples using a generative Language Learning Model (LLM); labeling all entity references present in the generated versions of the input samples; and aggregating the generated versions of the input samples and their corresponding labeled versions to form an expanded labeled dataset.

In a third aspect, there is provided a non-transitory computer-readable medium having stored thereon one or more sequences of instructions for causing one or more processors, to perform: receiving a set of input samples; performing a rephrasing operation to produce new versions of the set of input samples, wherein the new versions preserve semantic equivalence as the set of input samples but have different phrasing; generating a dataset of generated versions of the input samples using a generative Language Learning Model (LLM); labeling all entity references present in the generated versions of the input samples; and aggregating the generated versions of the input samples and their corresponding labeled versions to form an expanded labeled dataset.

In some embodiments, the rephrasing operation includes training a generative LLM in-context by providing the LLM with a prompt that instructs the LLM to create rephrased versions of a target sample. In some embodiments, the rephrasing operation includes training a generative LLM in-context to produce multiple rephrased versions of a single input sentence. In some embodiments, the rephrasing operation includes generating a modified version of an input sample by applying a random noise based on a random parameter. In some embodiments, the rephrasing operation includes generating a modified version of an input sample by applying a rephrasing function based on a random parameter.

In some embodiments, the method and system further perform applying a function to the generated versions of the input samples and corresponding placeholders for entity values, where the function replaces the corresponding placeholders with a list of potential values. In some embodiments, the function replaces the corresponding placeholders with actual values for a list of potential values for each entity.

In some embodiments, the expanded labeled dataset is used to train models in text-to-structured tasks.

In some embodiments, the method and system further perform converting a text-based query into an executable database query by: receiving a text-based query; interpreting the text-based query using a pre-trained Named Entity Recognition (NER) model to classify entities within the query thereby generating identified entities, wherein the NER model is trained on the expanded labeled dataset; converting the identified entities into a predetermined standardized format to create a structured representation of the text-based query; mapping the structured representation to a query format compatible with a target database to generate an executable query; executing the executable query on the target database to perform a requested search or transaction; and communicating a response from the target database back to a user device for presentation to a user. In some embodiments, the text-based query is tokenized into tokens, and the NER model tags each token with corresponding entity labels. In some embodiments, the NER model classifies the identified entities into respective categories based on labels used during training of the NER model.

In some embodiments, the method and system further perform receiving the expanded labeled dataset, wherein the expanded labeled dataset comprises rephrased versions of the set of input samples; using a generator in a Generative Adversarial Network (GAN) pipeline to select particular samples from the rephrased versions of the set of input samples, thereby generating selected samples; and feeding the selected samples along with corresponding entity values into a Named Entity Recognition (NER) model to train the NER model. In some embodiments, the method and system further perform: optimizing the generator and the NER model through backpropagation using a loss function; converting, using the trained NER model, a text-based query into a structured format by identifying and classifying entities within the text-based query; mapping the structured representation of the query to a query format compatible with a target database; and executing the mapped query on the target database to perform a requested search or transaction.

In some embodiments, the method and system further perform: evaluating the authenticity of the selected samples, using a discriminator of the GAN pipeline, by distinguishing between real and generated data.

In some embodiments, the structured format of the query includes representing each identified entity as a key-value pair. In some embodiments, the method and system further perform: generating synthetic text samples using a generator within a Generative Adversarial Network (GAN) pipeline; fine-tuning, using a pre-trained Language Learning Model (LLM) within the GAN pipeline the LLM with an inverse loss function of a subsequent model used to generate subsequent model output, the fine-tuning causing the LLM to generate more training samples for the subsequent model; evaluating a quality of entity recognition performed by the subsequent model using a discriminator, wherein the discriminator includes the NER model; and updating the generator based on the evaluation of the generated samples by the discriminator, the updating involving modifying internal parameters or changing a prompt to produce alternative samples.

In some embodiments, the method and system further perform: generating, using the pre-trained LLM, synthetic text samples that resemble the initial known dataset by fine-tuning the weights and biases within the LLM causing a change in a prompt. In some embodiments, the inverse loss function is propagated back through the GAN pipeline to the generator, providing a gradient indicating parameters of the generator to be adjusted. In some embodiments, the GAN pipeline includes an iterative cycle of generating new samples, evaluating them using the discriminator, and updating the generator based on the evaluation.

In some embodiments, the processor and the memory of the system are included in at least one computing device of the system, the at least one computing device being one of: a server; an edge device; a cloud computing platform; or a computing device at a deposit financial institution communicatively connected to at least one of the server, the edge device, the cloud computing platform, or an enterprise network.

### BRIEF DESCRIPTION OF THE DRAWINGS

FIG. 1 shows a high-level system for automating training of machine learning language models that convert a textual input to a structured format for downstream tasks, according to an example embodiment.

FIG. 2 illustrates a dataset generation process that employs a Language Learning Model (LLM) to generate a training dataset for training a model, according to an example embodiment.

FIG. 3 illustrates an exemplary system-flow diagram, showing both a system designed to translate and convert natural language text into executable database queries and an application use case, according to an example embodiment.

FIG. 4 illustrates an example conversion process for converting a text-base query to an output in a standardized format including entity information using a pre-trained named entity recognition (NER) model, according to an example embodiment.

FIG. 5 illustrates a process for data generation using a large language model (LLM) and named entity recognition (NER) model training, according to an example embodiment.

FIG. 6 shows a Generative Adversarial Network (GAN) pipeline in which a generator operates as a sample selector among a previously generated dataset, according to an example embodiment.

FIG. 7 illustrates a Generative Adversarial Network (GAN) pipeline for enhancing a training dataset and model performance for a Named Entity Recognition (NER) model, according to an example embodiment.

FIG. 8 discloses a computing environment in which aspects of the present disclosure may be implemented.

### DESCRIPTION

The example embodiments of this invention involve methods, systems, and computer program products for generating synthetic input samples. These samples are used to train models that convert textual input to structured formats for downstream tasks. The example pipeline described herein converts text to a JSON structure. However, it should be noted that these embodiments are not limited to converting text to a JSON structure and can be implemented in alternative ways. This includes converting text to other structured formats like YAML, XML, tabular form, graph structures, or any other predefined format.

Structured formats can be used as part of a pipeline for automatically generating new data to train a language model. Generally, the pipeline can operate to leverage Named Entity Recognition (NER) modeling to create a structured representation of an input token sequence, which can be efficiently utilized for various downstream tasks such as information extraction, data mining, text to database query, data integration, data visualization, knowledge graph storing/creation, document management, and archiving. The approach streamlines the handling of input token sequence for diverse applications, providing enhanced efficiency and accuracy in processing and managing textual data.

The technical challenges in NER modeling are diverse and impact various methodologies. Despite their high accuracy in NER, Generative Large Language Models pose significant computational demands due to their complex architecture. They require substantial labeled training data, limiting their scalability and practicality for certain applications. Similar to Generative Large Language Models, language models also face resource constraints and depend on labeled data for training. While they can be accurate in NER, their performance is influenced by the availability of computational resources and labeled training data. Conditional Random Fields (CRFs), effective in contextual modeling for NER, are computationally intensive and often necessitate handcrafted features for optimal performance. Rule-based models, reliant on predefined patterns, suffer from limited recall when encountering entities outside specified rules. SpaCy, a robust natural language processing library, exhibits reduced accuracy on unseen or divergent data despite efficient GPU utilization, adding computational overhead. Dictionary-based NER methods, while simple, suffer from low precision and recall due to reliance on dictionary completeness and accuracy, struggling notably with ambiguous terms. Semi-supervised and unsupervised learning approaches, though innovative, often sacrifice accuracy due to the absence of explicit labels in training, necessitating intricate feature engineering and model design. These challenges underscore the complexity required to enhance NER methodologies across different computational and data availability constraints.

By converting unstructured text into structured data, the technology described herein streamlines the processing and analysis of information across various fields, enhancing efficiency, accuracy, and the ability to leverage data for informed decision-making.

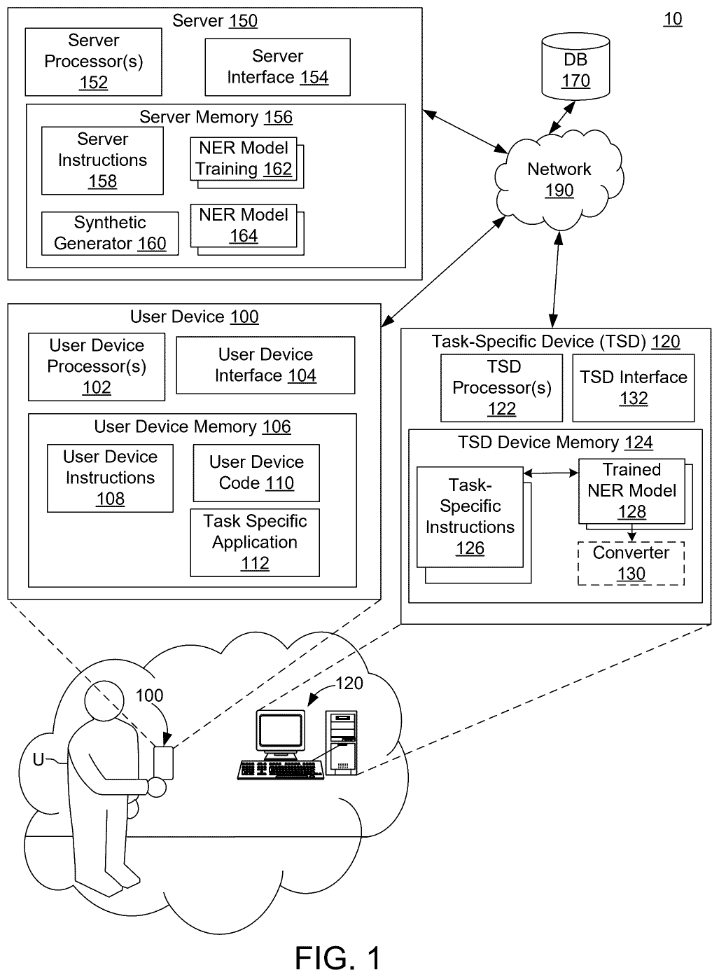

FIG. 1 shows a high-level system 10. The high-level system 10 can be used for the training, use, and deployment of artificial intelligence models, including those that convert a textual input to a structured format for downstream tasks, according to an example embodiment. The system 10 includes a user device 100, a task-specific device (TSD) 120, and a server 150, each of which is connected to a network 190.

The user device 100 is a device used by a user U that can be used as part of processes described herein. The user device 100 can include one or more aspects described elsewhere herein such as in reference to the computing environment 10 of FIG. 1. In many examples, the user device 100 is a personal computing device, such as a smart phone, tablet, laptop computer, or desktop computer. But the user device 100 need not be so limited and may instead encompass other devices used by a user as part of processes described herein. In the illustrated example, the user device 100 can include one or more user device processors 102, one or more user device interfaces 104, and user device memory 106, among other components.

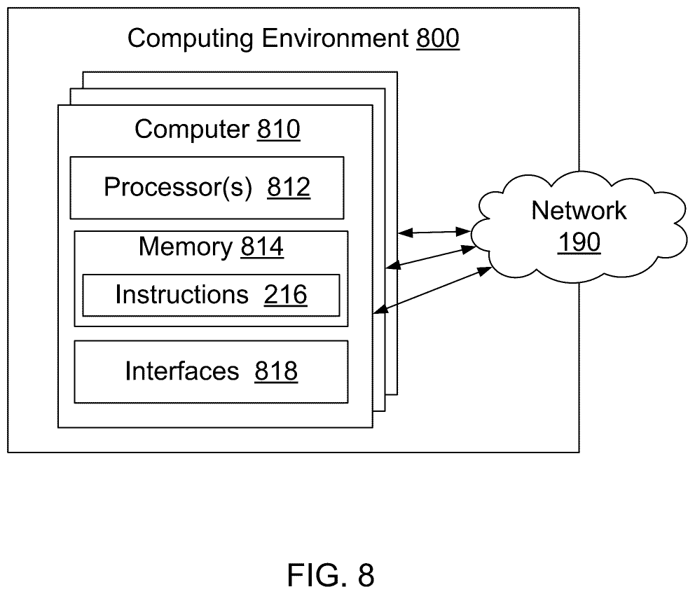

The one or more user device processors 102 are one or more components of the user device 100 that execute instructions, such as instructions that obtain data, process the data, and provide output based on the processing. The one or more user device processors 102 can include one or more aspects described below in relation to the one or more processors 812 of FIG. 8.

The one or more user device interfaces 104 are one or more components of the user device 100 that facilitate receiving input from and providing output to something external to the user device 100. The one or more user device interfaces 104 can include one or more aspects described below in relation to the one or more interfaces 818 of FIG. 8.

The user device memory 106 is a collection of one or more components of the user device 100 configured to store instructions and data for later retrieval and use. The user device memory 106 can include one or more aspects described below in relation to the memory 814 of FIG. 8. As illustrated, the user device memory 106 stores user device instructions 108 and the user device instructions 110.

The user device instructions 108 are a set of instructions that, when executed by one or more of the one or more user device processors 102, cause the one or more user device processors 102 to perform an operation described herein. In examples, the user device instructions 108 can be those of a mobile application (e.g., that may be obtained from a mobile application store, such as the APPLE APP STORE or the GOOGLE PLAY STORE). The mobile application can provide a user interface for receiving user input from a user and acting in response thereto. The user interface can further provide output to the user. In some examples, the client instructions 108 are instructions that cause a web browser of the user device 100 to render a web page associated with a process described herein. The web page may present information to the user and be configured to receive input from the user and take actions in response thereto.

In some embodiments, user device 100 has a task-specific application 112 installed, which executes instructions to prompt the task-specific device 120 to perform designated tasks.

The task-specific device 120 operates to perform one or more specific tasks. In the illustrated example, the task-specific device 120 includes one or more task-specific device processors 122, task-specific device memory 124, and task-specific device interface 132.

The one or more task-specific device processors 122 are one or more components of the task-specific device 120 that execute instructions, such as instructions that obtain data, process the data, and provide output based on the processing. The one or more task-specific device processors 122 can include one or more aspects described below in relation to the one or more processors 812 of FIG. 8.

The task-specific device memory 124 is a collection of one or more components of the task-specific device 120 configured to store instructions and data for later retrieval and use. The task-specific device memory 124 can include one or more aspects described below in relation to the memory 814 of FIG. 8. The task-specific device memory 124 can store task-specific instructions 126. The task-specific device memory 124 also can store one or more trained NER models 128 that are used in conjunction to with either task-specific instructions 126 or a converter 130 to perform specific tasks.

Task-specific instructions 126 are instructions that, when executed by the one or more processors 122, cause the one or more task-specific device processors 122 to perform one or more operations described elsewhere herein.

The one or more task-specific device interfaces 132 are one or more components of the task-specific device 120 that facilitate receiving input from and providing output to something external to the task-specific device 120. The one or more task-specific device interfaces 132 can include one or more aspects described below in relation to the one or more interfaces 818 of FIG. 8.

The server 150 is a server device that functions as part of one or more processes described herein. In the illustrated example, the server 150 includes one or more server processors 152, one or more server interfaces 154, and server memory 156, among other components.

The one or more server processors 152 are one or more components of the server 150 that execute instructions, such as instructions that obtain data, process the data, and provide output based on the processing. The one or more server processors 152 can include one or more aspects described below in relation to the one or more processors 812 of FIG. 8.

The one or more server interfaces 154 are one or more components of the server 150 that facilitate receiving input from and providing output to something external to the server 150. The one or more server interfaces 154 can include one or more aspects described below in relation to the one or more interfaces 818 of FIG. 8.

The server memory 156 is a collection of one or more components of the server 150 configured to store instructions and data for later retrieval and use. The server memory 156 can include one or more aspects described below in relation to the memory 814 of FIG. 8. The server memory 156 can store server instructions 158. The server memory 156 also can store NER model training instructions 162. The server memory 156 also can store instructions that cause the server processors 152 to operate as a synthetic generator 160 configured to generate a training dataset for training a model (e.g., NER model 164). Synthetic generator 160 is also referred to as a dataset generator. Synthetic generator 160 may contain one or more LLMs.

The server instructions 158 are instructions that, when executed by the one or more server processors 152, cause the one or more server processors 152 to perform one or more operations described elsewhere herein.

The network 190 is a set of devices that facilitate communication from a sender to a destination, such as by implementing communication protocols. Example networks 190 include local area networks, wide area networks, intranets, or the Internet.

System 10 also can include a database 170 in communication via network 190. In this example implementation, other device 120 can query database 170 using queries generated according to the embodiments described herein.

Referring to both FIG. 1 and FIG. 8, in some embodiments, user device memory 106, task-specific device memory 124, server memory 156 and memory 814 are non-transitory memory.

Also, in some embodiments, task-specific instructions 126, trained NER model 128 and converter 130 can be incorporated into server 150, as can database 170.

In some embodiments, server 150 operates to train a text-to-structure model. To do so, the training set that server 150 uses to train the text-to-structure model needs to be sufficient. If the dataset size is below a certain threshold or the text-to-structure model performs poorly, then indicates the dataset may be insufficient. Server 150 operates as a dataset generator to generate and ensure an adequate amount of training examples for the text-to-structure model.

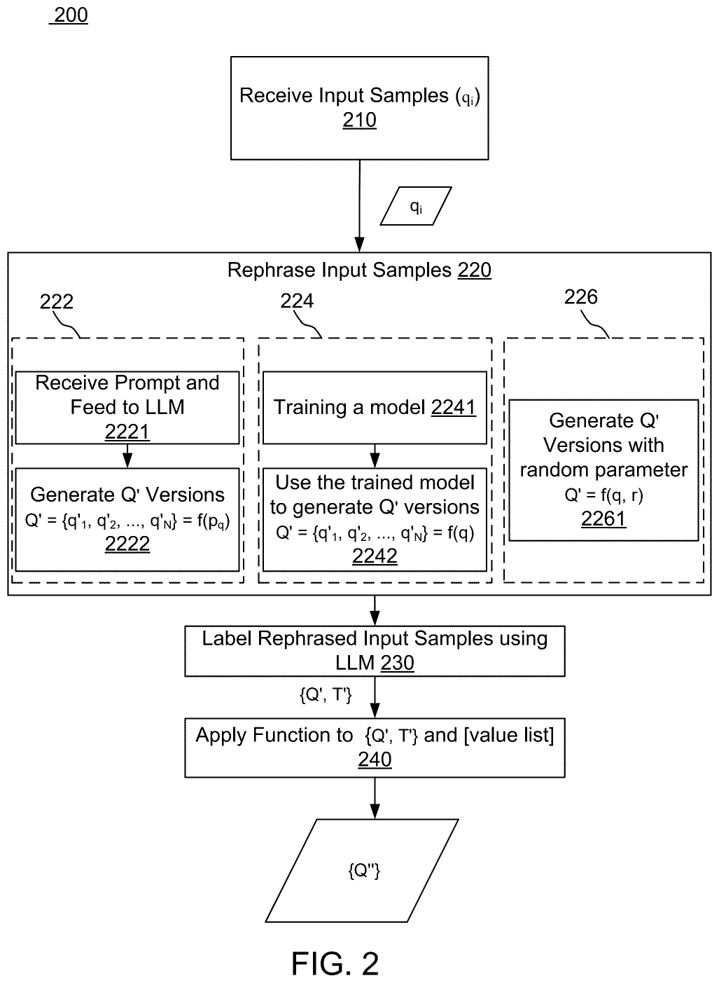

FIG. 2 illustrates a dataset generation process 200 that employs a Language Learning Model (LLM) to generate a training dataset for training a model, according to an example embodiment. Example LLMs include the CHATGPT and GPT series of models by OPENAI, the LLAMA series of models by META, the GEMINI series of models by ALPHABET, and the CLAUDE series of models by ANTHROPIC, among others. Synthetic generator 160 of server 150 (FIG. 1) operates to perform the data generation process 200 by using an LLM to expand a small set of known input samples, simulating a more extensive training dataset. The synthetic generator uses instances of an LLM as follows. In some embodiments, instances of the same type of LLM are used. However, in other embodiments, instances of the different types of LLMs are used.

A receive operation 210 includes receiving input samples qᵢ, where qᵢ belongs to an original set of input samples Q. In turn, a rephrasing operation 220 performs producing new versions of the input samples qᵢ that preserve semantic equivalence (e.g., retain the same meaning) but have different phrasing. Here, “phrasing” refers to the specific choice and arrangement of tokens (e.g., words or parts thereof) used to express an idea. Thus, one aspect provides different phrasing that conveys the same meaning using different tokens or token sequence structures (e.g., sentences). This can be represented as an expanded queries dataset Q′=f(qᵢ∈Q), where Q′ represents the set of newly generated versions of the input samples qᵢ where qᵢ belongs to an original set of input samples Q.

To test if the new versions retain the same meaning as the set of input samples, various evaluation techniques can be employed such as human evaluation, semantic similarity metrics or downstream task performance. Human annotators can compare the original input samples with their corresponding new versions. They can, in turn, assess whether the meaning is preserved or if there are any significant changes in meaning. This evaluation can be done through pairwise comparisons, where annotators rank the similarity or judge the equivalence of meaning.

Automated metrics can be utilized instead of or in addition to human evaluation such as by using techniques involving cosine similarity, BLEU (BiLingual Evaluation Understudy), ROUGE (Recall-Oriented Understudy for Gisting Evaluation), or embedding space comparisons (e.g., by embedding the content in an embedding space using a technique such as Word2Vec) similarity tests to measure the semantic similarity between the original input samples and the new versions. These metrics compute the similarity based on word or phrase embeddings, n-gram overlaps, or other linguistic features.

The performance of a downstream task can also be used to test whether the new versions retain the same meaning, such as by using information retrieval or question answering, using the original input samples and the new versions as queries. If the performance remains consistent or comparable, it suggests that the new versions retain the same meaning.

Expanded queries dataset Q′ is also referred to as a rephrased version of the input samples Q. This process of generating new versions of the input samples is also known as augmentation. So as to not confuse the various datasets generated by the pipeline, different terminology is used to describe them. Augmentation by rephrasing operation 220 can be performed in different ways depending on the desired outcome.

Examples of rephrasing operation 220 are now described in detail. In an example implementation, rephrasing operation 220 performs an in-context rephrasing process 222 with an in-context LLM training process. The in-context rephrasing process 222 can include training a generative LLM in-context. In an example implementation, in-context rephrasing process 222 can include a prompt receive operation 2221 that can receive a prompt that instructs the generative LLM to create rephrased versions of a target sample q. Training a generative LLM in-context can thus include providing the LLM with a prompt that instructs the generative LLM to create rephrased versions of a target sample. To accomplish this, the synthetic generator 160 executes the receive prompt operation 2221 that performs receiving the prompt with instructions. The prompt is then provided to the generative LLM. In an example implementation, the prompt includes examples and guidance for the augmentation task for generating additional training samples.

In turn, the in-context rephrasing process 222 performs a generation operation 2222 to generate, using the generative LLM, a dataset of generated versions of the input samples. In this case, the generated versions are represented as expanded queries dataset Q′={q′₁, q′₂, . . . , q′_{N}}=f(p_{q}), where Q′ represents the generated rephrased sample set corresponding to the input sample q, {q′₁, q′₂, . . . , q′_{N}} are N rephrased versions of the target sample, and p_{q} serves as the in-context prompt outlining the augmentation task for an input sample q, with p relating to the instruction prompt.

In another example implementation of rephrasing operation 220, a fine-tuned LLM process 224 is used, where an LLM is fine-tuned to generate N rephrased versions of a single input sentence based on the input samples qᵢ. The fine-tune LLM process 224 can include a training operation 2241.

Training operation 2241, in some embodiments, includes training a model with clustered data. Training operation 2241, in some embodiments, includes fine tuning a model with clustered data. Training operation 2241, in some embodiments, can include updating the LLM according to provided clustered data. Training operation 2241 can be performed prior to receiving the input samples qᵢ obtained by receive operation 210, and fine-tuned LLM process 224 may include selecting, loading, or accessing the already trained (or fine-tuned model).

Fine-tuned LLM process 224 can further include rephrasing operation 2242. Rephrasing operation 2242 includes using the model that was trained or fine-tuned in operation 2241 to generate a rephrased version of an input sample q (e.g., an input sample from the input samples qᵢ obtained by receive operation 210). In some examples, the LLM is trained with data that contains clusters of sentences having the same meaning and interchangeable usage. Here, the generated versions are represented as expanded queries dataset Q′={q′₁, q′₂, . . . , q′_{N}}=f(q).

In another example of rephrasing operation 220, a random parameter process 226 can be used. Random parameter process 226 includes a random parameter modification operation 2261 to generate a modified version of input sample q by applying either random noise or rephrasing function based on a random parameter r.

In some embodiments, random noise is applied to introduce variability or test the robustness of the model. In an example implementation, this approach involves making small, unpredictable changes to the text that may not preserve the original meaning. For example, random noise might be used to simulate errors or introduce slight distortions in data to assess how well the model handles such variations.

As used herein, “random” refers to something generated or obtained from inherently unpredictable physical processes, such as radioactive decay or thermal noise. In other words, random values occur without any predictable pattern or bias, and their outcomes cannot be determined in advance. As used herein, “pseudorandom” refers to something generated or obtained using a finite, nonrandom computational process. In other words, pseudorandom values refer a set of values that is statistically random but is derived from a known starting point. Pseudorandom sequences may, therefore, exhibit statistical randomness while being generated by an entirely deterministic causal process.

In some embodiments, rephrasing (e.g., using a rephrasing function) is applied to produce meaningful variations of the original text while preserving its intended meaning. Rephrasing can involve altering the structure or wording of the text to create different expressions of the same idea. This is useful for generating diverse query variations or creating paraphrases that convey the same information in different ways.

For example, an input sample q and a random parameter r are received, and random parameter modification operation 2261 generates a modified version of q based on r. If random parameter r indicates a need for variability or error simulation, random noise is applied. If random parameter r directs the process towards meaningful text variations, rephrasing is performed.

In some embodiments, the output is represented as Q′=f(q, r), where Q′ is the generated set of modified samples corresponding to input sample q, with r guiding the type of modification. The rephrasing operation 220 creates N different rephrased versions for each initial known input sample q. The value of N can vary. In some examples, N can be 3, 10, or hundreds of versions. As such for each input sample, multiple distinct rephrased versions are generated to provide a diverse set of variations while maintaining the original meaning. In some embodiments, Nis a fixed number.

As described above, various ways to rephrase input samples can be performed. In some implementations, a default rephrase process is used. In other implementations, a rephrase function selector (not shown) is used to selects one or more of the rephrase processes (e.g., among processes in-context LLM training process 222, fine-tuned LLM process 224, random parameter process 226, combinations thereof, or others). In some examples, the rephrase function selector can select the process based on one or more factors, such as ease of use for rephrasing, amount of additional training or fine-tuning required, accuracy, efficacy, other factors, or combinations thereof. In some examples, the selecting can include determining whether a trained or fine-tuned model for a particular kind of rephrasing exists. If so, that model is selected and used. If not, a process, such as in-context LLM training process 222 is selected and used.

In turn, dataset generation process 200 involves a labeling operation 230 that performs identifying and labeling all the entity references present in new versions of the input samples with placeholders. The new versions of the input samples are also referred to as “rephrased versions of the input samples” or simply “rephrased samples.” In an example implementation of labeling operation 230, a second instance (or other) LLM identifies and labels all the entity references in the generated samples with placeholders such that labeled synthetic dataset T′=f(qᵢ∈Q′), where labeled synthetic dataset T′ represents the output, which is a labeled version of the rephrased samples. This is accomplished, in some embodiments, by applying the function f(qᵢ∈Q′) to each generated sample qᵢ from the expanded queries dataset Q′, where Q′ is a set of N rephrased versions of the input samples (e.g., from a sentence), represented as {q′₁, q′₂, . . . , q′_{N}}. In simpler terms, the second instance of LLM takes the rephrased versions of the input samples (Q′) and applies a labeling process to mark the entity references with placeholders. The resulting labeled versions (labeled synthetic dataset T′) are then used for further processing or analysis.

Therefore, an expanded labeled dataset D′ is defined as the aggregation of the rephrased versions of the input samples Q′ and their corresponding labeled versions T′. Here, Q′ represents the set of N rephrased versions of the input samples, denoted as {q′₁, q′₂, . . . , q′_{N}}. Labeled synthetic dataset T′ represents the output, which is the labeled version of the rephrased samples. The expanded labeled dataset D′ is represented as D′={(qᵢ, tᵢ)∈Q′, T′}, where each (qᵢ, tᵢ) pair signifies a rephrased version of an input sample along with its corresponding labeled version. This aggregated dataset D′ serves as a resource for training and evaluating models in text-to-structured tasks.

Optionally, the expanded labeled dataset D′ is presented via a user interface of a device, enabling visual verification by a user (e.g., an expert in the particular data domain) of the generated samples Q′ and entities T′.

It may be the case that the expanded labeled dataset D′ does not provide a sufficient dataset for training an NER model. Accordingly, in some embodiments, a second generator is utilized to enrich the expanded labeled dataset D′ with a mix of elements, thereby generating a significantly larger set.

In some embodiments, a value replacement operation 240 performs applying a particular function to the expanded queries dataset Q′ together with the corresponding placeholders for entity values corresponding to T′, represented as {Q′, T′}, along with a list of potential values that each entity could be assigned. This list of potential values could include values (e.g., for categorical instances, such as [“APPL”, “GOOGL”, “USB”] for a “ticker” entity, or numerical within a limited set of possible occurrences, like [0,1,2,5,10] for a “tenor” entity) or a range (for example, between 0 to 20). The augmented synthetic dataset Q″ may be produced by combining all potential values within the placeholders for each sample in the expanded queries dataset Q′.

An example of a particular function that can be applied to the augmented samples is a value replacement function that, when executed, assigns or replaces placeholders in the augmented samples with actual values for a list of potential values shown in FIG. 2 as “[value list]”. A value replacement function is also sometimes referred to as an entity replacement function. In this function, the expanded queries dataset Q′ and the corresponding placeholders for entity values corresponding to T′ are provided as input, along with a list of potential values for each entity. For example, given an expanded queries dataset Q′ that contains the sentence “I bought TICKER stocks at TENOR years maturity”, “TICKER” represents a placeholder for a stock symbol entity, and “TENOR” represents a placeholder for a duration entity. The particular function, in this case, would take Q′ and T′ as input along with the lists of potential values for the “TICKER” and “TENOR” entities. For the “TICKER” entity, the list of potential values could be [“APPL”, “GOOGL”, “USB”], representing different stock symbols. For the “TENOR” entity, the list of potential values could be [0, 1, 2, 5, 10], representing different durations in years. The value replacement function would then replace the placeholders in expanded queries dataset Q′ with the corresponding potential values for each entity. For example, one possible output could be “I bought GOOGL stocks at 2 years maturity.” This particular function, in the form of value replacement, allows for the generation of diverse variations of the augmented samples by substituting the placeholders with different potential values for each entity.

The augmentation process described above provides a significant increase in the number of samples, which is directly related to the number of entities and associated values. This results in a substantial number of samples in augmented synthetic dataset Q″, each paired with its corresponding target T″. As a result, a labeled set is formed, which can be effectively utilized to train subsequent models.

In some embodiments various combinations of values within the placeholders for each sample can be used for training the models. This approach ensures that the models are exposed to a wide range of variations and scenarios, leading to better performance and generalization.

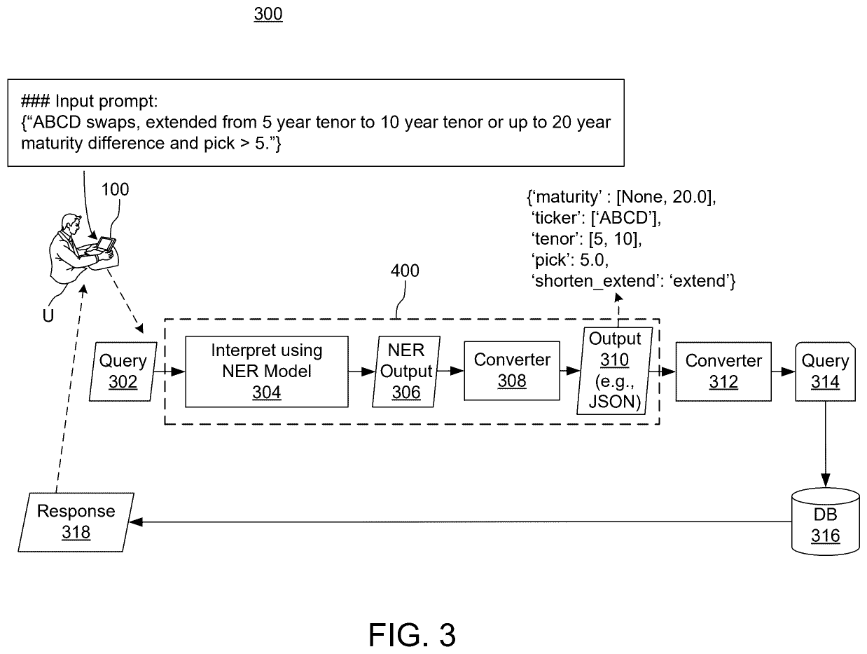

FIG. 3 illustrates an exemplary system-flow diagram 300, showing both a system designed to translate and convert natural language text into executable database queries and an application use case, according to an example embodiment. The process of system-flow diagram 300 begins by an input operation in the form of a text-based query 302 that performs receiving a text-based query (e.g., input from a user U received over a keyboard, microphone, or other user input device of user device 100). The text-based query serves as the input for a text-to-query conversion task. In this example use case, text-based query is “ABCD swaps, extended from 5 year tenor to 10 year tenor or up to 20 year maturity difference and pick >5 . . . ”

Responsive to receiving the text-based query, the system executes an interpret operation 304 that performs interpreting the text-base query using a pre-trained Named Entity Recognition (NER) model. In an example embodiment the pre-trained NER model has been trained using the augmented synthetic dataset Q″ generated according to the embodiments described above in connection with FIG. 2.

The pre-trained NER model interprets the natural language input contained in the text-base query. In some embodiments, the interpret operation 304 includes identifying and classifying entities within the text, such as names, dates, numerical values, and other relevant pieces of information that are essential for forming the database query.

The NER output 306 from the pretrained NER model obtained from the interpret operation 304 is a structured output containing identified entities with their respective classifications. The NER output 306 is then passed to a first converter operation 308. First converter operation 308 takes the NER output 306 from the NER model and performs necessary transformations to convert the entity information of the structured output into a standardized format. The component that performs the first converter operation 308 is referred to as a first converter. In the example implementation, the example standardized format is JSON. The results, output 310, are a structured representation of the text-base query that can be easily processed by machines. In an example, the structure representation includes the keys corresponding to maturity, ticker, tenor, pick, and shorten/extend and having respective values [None, 20.0], [ABCD], [5, 10], 5.0, and extend.

Interpret operation 304 and first converter operation are collectively referred to as a conversion process 400.

Following the generation of the output 310 (e.g., JSON output), a second converter operation 312 performs mapping the output 310 to an actual query format that is compatible with a target database 316 or other resource that stores relevant data. The output of this stage is an executable query 314 which is an executable query corresponding to the database query language of target database 316, such as SQL, or another kind of query or application programming interface call for obtaining data from the data store.

The executable query 314, is sent to database 316, which is the repository containing the data that the user intends to access or manipulate. The database processes the executable query 314 by performing a corresponding task. In this example, the corresponding task is performing a requested search or transaction.

Once the database 316 has executed the query, it generates a response 318 containing the results or the outcome of the query execution, which is then communicated back to user device 100 to be presented to the user U via the one or more user device interfaces 104 of user device 100. The entire process flow depicted in FIG. 3 demonstrates a streamlined approach to querying databases using natural language using an NER model that has been pre-trained as described herein, thereby making data retrieval and interaction more accessible and user-friendly.

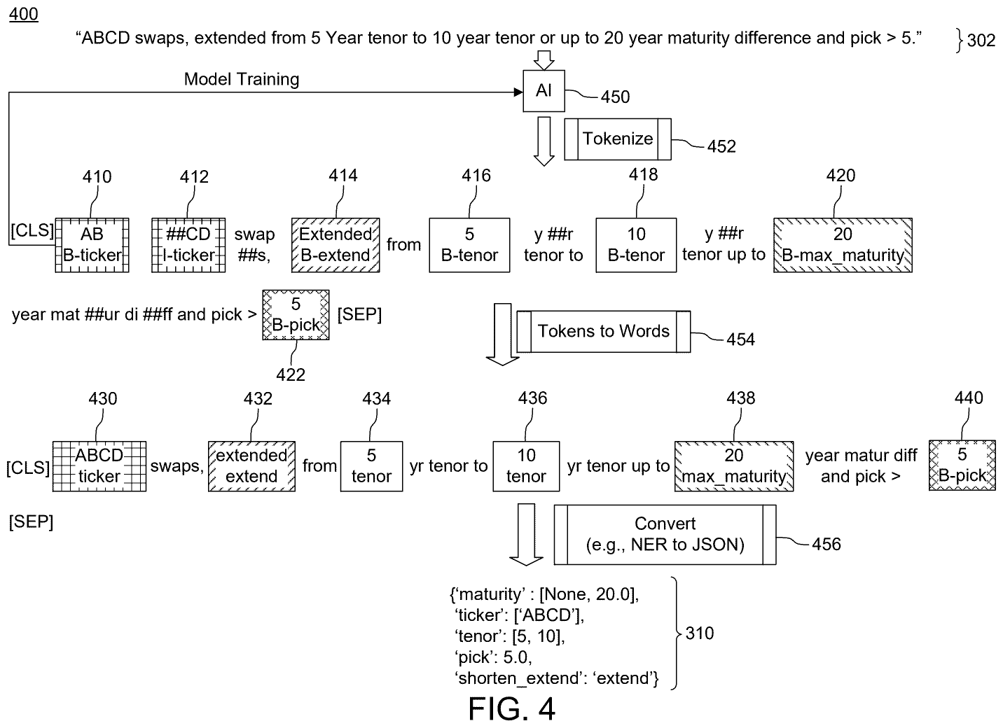

FIG. 4 illustrates an example conversion process 400 for converting a text-based query 302 to an output 310 in a standardized format including entity information using a pre-trained named entity recognition (NER) model, according to an example embodiment. As shown in FIG. 4, artificial intelligence 450 can be used for model training as well. Initially, a tokenization operation 452 performs tokenizing the text-based query 302 into tokens. The tokens can be words, subwords, or symbols depending on the tokenizer's granularity. In the context of NER, these tokens are then analyzed and tagged with appropriate entity labels. “B-ticker” in block 410, I-ticker” in block 412, “B-extend” in block 414, “B-tenor” in block 416 and block 418, “B-max_maturity” in block 420 and “B-pick” in block 422, for example, are labels with “B-” representing “begin”.

In the example shown, B-ticker (Begin ticker) is a label marks the beginning of a ticker symbol, which is a series of characters assigned to a security or stock for trading purposes. I-ticker (Inside ticker) is a label that is used for any subsequent parts of a multi-word ticker symbol, following the “B-ticker”. In other words, if the ticker symbol spans multiple words, “B-ticker” marks the start and “I-ticker” marks the continuation. B-extend (Begin extend) is a label that marks the beginning of a term or phrase related to an extension of some sort, possibly an extension of a financial term, contract, or security feature. B-tenor (Begin tenor) is a label that indicates the start of a term related to the tenor, which in finance refers to the length of time until a financial contract expires, or a debt must be repaid. B-max_maturity is a label that refers to the maximum maturity date of a financial instrument, such as the longest duration until the principal amount of a bond or other debt instrument is due to be paid back. B-pick (Begin pick) is a label that is used to mark the beginning of a selection or a chosen item.

These labels are used to systematically annotate and identify specific parts of text related to a specific topic, ensuring that each component is clearly marked for further processing or analysis.

In some embodiments, after tagging, a tokens-to-words operation 454 assembles the tokenized and tagged entities into their full word or phrase representation as represented by blocks 430, 432, 434, 436, 438 and 440. It should be understood that tokenization operation 452 can include tokens-to-words operation 454. Tokenization operation 452 and tokens-to-words operation 454 operate in conjunction to make it possible to convert the identified and tagged entities into a structured format, like JSON, in a manner that preserves the meaning and relationships of the original text.

Referring to FIG. 3 and FIG. 4, the NER marks each token (e.g., words or subwords) of the input prompt that is determined to be relevant. Once those tokens are determined, a first conversion operation 456, e.g., performed by a first converter, converts the output of the NER model to a JSON formatted query.

The process begins with a user submitting a text-based query 302 to a pretrained NER model that performs interpret operation 304. This text-based query 302 might contain various terms, some of which are pertinent to the intent of the user U while others might be considered “noise” or irrelevant to the actual information need.

The pre-trained NER model parses the query and analyzes the context of each term. Using the knowledge it gained during training, the pre-trained NER model assesses which terms are likely to be meaningful entities. As the pre-trained NER model processes the text-based query 302, it identifies entities according to the categories it has been trained to recognize. In the example of FIG. 4, the text-based query is “ABCD swaps, extended from 5 year tenor to 10 year tenor or up to 20 year maturity difference and pick >5.”

As used herein, “B-” and “I-” prefixes are used as part of the BIO tagging scheme, which is a common format for marking up entities in text. The BIO scheme stands for Beginning, Inside, and Outside, and it is used to indicate the position of words within an entity. These tags are particularly useful for multi-word entities. Here, the “B-” prefix stands for “beginning” and is used to tag the first word of a multi-word entity. If “ABCD” in the example query is considered an entity representing a stock ticker symbol, it could be tagged as “B-ticker” to denote that “ABCD” is the beginning of a ticker entity. The “I-” prefix stands for “inside” and is used to tag subsequent words of a multi-word entity. If the ticker symbol were more than one word, each subsequent word in the entity would be tagged with “I-ticker.” In the given example, “ABCD” is a single word, so there may not be a “I-ticker” tag since there are no additional words inside the ticker entity. Thus, in a typical scenario, “ABCD” as a single string would be considered a single entity, especially if it is a known ticker symbol in the training data of the NER model.

However, there could be scenarios where “ABCD” might be tokenized and classified such that “AB” is labeled as a “B-ticker” entity and “CD” is labeled as an “I-ticker” entity. This could occur due to a few reasons: The tokenizer used in the NER system might split “ABCD” into “AB” and “CD” if it has been trained or configured to recognize “AB” and “CD” as separate tokens. This could happen if, for instance, the tokenizer is sensitive to capitalization changes within a single word. It may also be the case if the NER model has been trained on data where “AB” and “CD” often appear separately and in the context of ticker symbols, it might learn to incorrectly tokenize and classify “ABCD” into two separate entities.

Machine learning models, including NER models, are not perfect and can make mistakes. It is possible that due to an error, the model might incorrectly break down “ABCD” and assign the “B-ticker” and “I-ticker” tags separately to “AB” and “CD.”

Concurrently, the pre-trained NER model disregards terms that do not correspond to these categories. In the same example, words like “swap ##s”, “from”, “y ##r tenor to”, “y ##r tenor up to”, “year mat ##ur di ##ff and pick >” might be ignored because they do not provide specific information about the request; they are simply part of the natural language phrasing.

The terms identified as entities are then classified into their respective categories. This classification is based on the labels that were used during the training of the NER model. Each identified entity is tagged with the appropriate category.

After classification, the query is transformed by first conversion operation 456 into an output 310 in a structured format. In this example the first conversion operation 456 coverts the output of the NER to a JSON object. However, it also be converted to an XML file, or any other structured data format. In this format, each entity is represented as a key-value pair, where the key is the entity category and the value is the actual entity extracted from the query. For example:

{‘maturity’ : [None, 20.0],
‘ticker’: [‘ABCD’],
‘tenor’: [5, 10],
‘pick’: 5.0,
‘shorten_extend’: ‘extend’}

By converting the text-based query into a structured format, the NER model effectively filters out irrelevant terms and organizes the important information in a way that can be easily utilized by other systems, such as databases, for further processing or to carry out the user's intended action.

It should be understood that the types of entities can vary. Entities can be, for example, names of people, organizations, locations, expressions of times, quantities, monetary values, percentages, etc.

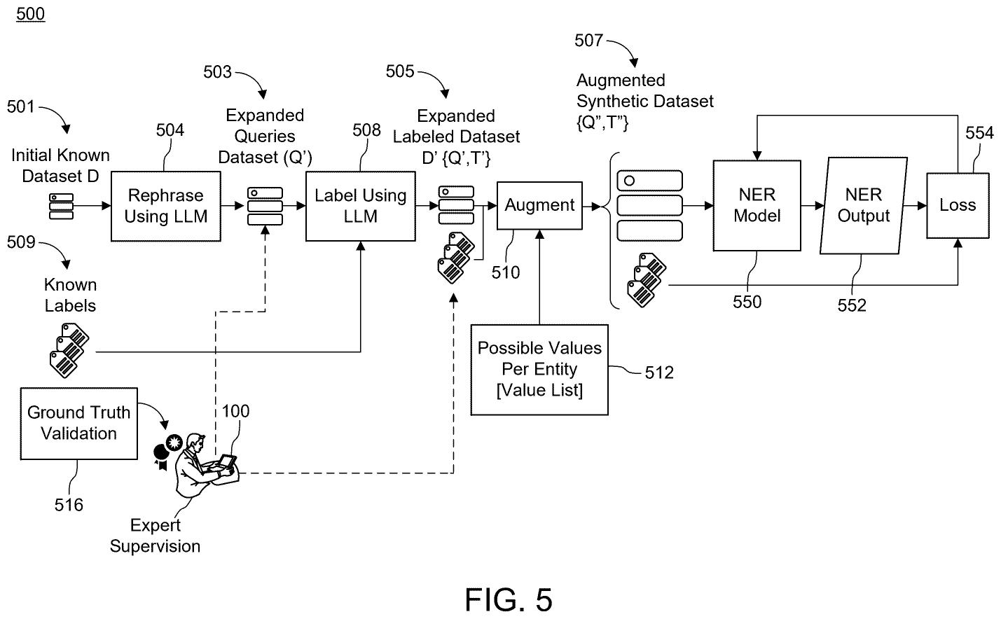

FIG. 5 illustrates a data generation process 500 using large language models (LLM) and named entity recognition (NER) model training, according to an example embodiment. Generally, data generation process 500 leverages the capabilities of pretrained LLMs to expand a small set of known samples into a relatively larger, labeled dataset. The labeled dataset is then used to train an NER model 550.

As used herein, an initial known set of input samples is denoted as D, where D consists of pairs (q₁, t₁), (q₂, t₂), . . . , (qᵢ, tᵢ). Each qᵢ represents an input sample, such as a sequence of tokens or any textual input such as a sentence. Each tᵢ represents a targeted output corresponding to qᵢ. Targeted output tᵢ provides the information from qᵢ in a structured format such as JSON (JavaScript Object Notation). The structured format contains entities eᵢ which function as columns of a database that will be utilized in a query, along with their actual values. In other words, each entity eᵢ includes the specific value extracted from the input sample. “i” is an index variable that distinguishes each element in a dataset. Thus, each qᵢ represents an individual input sample within the dataset D; each “tᵢ” corresponds to the targeted output associated with the input sample qᵢ; and each “eᵢ” denote an entity within the structured format provided by tᵢ.

In an example implementation, given an initial known dataset D={(q₁,t₁), (q₂,t₂), . . . , (qᵢ, tᵢ)} of input samples qᵢ with tᵢ being the targeted output associated with each input sample qᵢ, each qᵢ∈Q is a sentence or any textual input where Q represents the set of input samples qᵢ, and each tᵢ∈T provides the targeted outputs associated with input samples qᵢ in a structured format, showing the entities eᵢ∈E (for instance columns of a DB that will be used in a query) with actual values in the input sentence.

In some embodiments, whether the available quantity of data D is sufficient to train a main text-to-structure model is tested. If a determination is made that the available quantity of data D is sufficient to train a main text-to-structure model (also referred to as a core, primary or central text-to structure model). Thus, if sufficient data is available in dataset D, the system can train a main text-to-structure model directly. However, if a determination is made that only a small amount of data is available, the system uses a synthetic generator as described herein to create additional training examples.

In some embodiments, sufficiency of the available quantity of dataset D is tested by comparing a number of input samples qᵢ in the dataset D to predetermined requirements for training the main text-to-structure model. If the dataset size is below a certain threshold, it may be insufficient.

In some embodiments, sufficiency of the available quantity of dataset D is tested by training a preliminary version of the main text-to-structure model using the available dataset D. In turn, the model's performance is evaluated on a validation set. Metrics such as accuracy, F1 score, or other relevant performance indicators can be used. If the model performs poorly, it indicates that the dataset is insufficient.

In some embodiments, if during the training process, the system relies on the dataset generator to create additional training examples more than a predetermined number of times, a determination can be made that it implies that the initial dataset is insufficient.

This approach combines the efficiency of automated data generation with the accuracy of human validation, resulting in a high-quality training resource for the NER model.

Referring to FIG. 5, the data generation process 500 begins by receiving initial known dataset 501 (D) that includes samples of the text, along with corresponding known labels 509. The corresponding known labels 509 might indicate various entities or pieces of information within the text, such as “B-ticker,” “I-ticker,” “B-extend,” etc., described in connection with FIG. 4.

In turn, a rephrasing operation 504 performs rephrasing the initial known dataset 501 using a first instance of an LLM. Rephrasing operation 504 produces an expanded queries dataset Q′ of the initial known dataset samples qᵢ according to at least one of the three rephrasing options: in-context LLM training process 222, fine-tune generative LLM process 224, or random parameter training process 226 described above in connection with FIG. 2. The expanded queries dataset Q′ 503 of the initial known dataset samples qᵢ is also referred to as rephrased versions of the input samples or simply Q′. While Q′ is relatively larger than dataset D, it may not be large enough to train a model. Accordingly, a labeling operation 508 applies a second instance of the pre-trained LLM to identify and label all the entity references in the rephrased versions of the input samples Q′ using known labels 509 or placeholders such that labeled dataset T′=f(qᵢ∈Q′), where labeled dataset T′ 505 represents the output, which is a labeled version of the rephrased versions Q′ of the input samples qᵢ. This is accomplished, in some embodiments, by applying the function f(qᵢ∈Q′), where Q′ is a set of N rephrased versions of the input samples qᵢ (e.g., from a sentence) and represented as {q′₁, q′₂, . . . , q′_{N}}. In simpler terms, the second instance of LLM takes the rephrased versions of the input samples Q′ and applies a labeling process to mark the entity references with labels or placeholders (collectively referred to simply as labels). In an example implementation, the entity values (obtained from the input samples) are replaced with placeholders. The resulting labeled dataset T′ are then used for further processing or analysis.

In some embodiments, the second instance of LLM is the same type of LLM as the first instance of the LLM. In some embodiments, the second instance of LLM is a different type of LLM than the first instance of the LLM.

The labeled dataset T′ 505 can be further augmented into an augmented synthetic dataset {Q″, T″} 507 by an augment operation 510 that performs incorporating a list of possible values for each entity 512. In an example implementation, this is performed by a value replacement operation as described above in connection with FIG. 2, where the value replacement operation 240 performs applying a particular function to the samples in expanded queries dataset Q′ together with the corresponding placeholders for entity values corresponding to labeled dataset T′, represented as {Q′, T′} 505, along with a list of potential values that each entity could be assigned. This list of potential values could include values (e.g., for categorical instances, such as [“APPL”, “GOOGL”, “USB”] for a “ticker” entity, or numerical within a limited set of possible occurrences, like [0,1,2,5,10] for a “tenor” entity) or a range (for example, between 0 to 20). The augmented synthetic dataset Q″ may be produced by combining all potential values within the placeholders for each sample in the expanded queries dataset Q′. This results in a substantial number of augmented samples Q″, each paired with its corresponding target T″. Indeed, this final stage of augmentation results in an exponential increase in the number of samples, in correlation to the count of entities and associated values effectively guaranteeing a substantial number of samples Q″, each paired with the corresponding target T″, thus forming a labeled set that could be used to train a subsequent model.

In some embodiments, the number of samples Q″ is a fixed number.

An example of a particular function that can be applied to the augmented samples is a value replacement function that, when executed, assigns or replaces placeholders in the augmented samples with actual values for a list of potential values shown in FIG. 5 as “[value list]” 512. The augment operation allows for the generation of diverse variations of the augmented samples by substituting the placeholders with different potential values for each entity and thus provides a significant increase in the number of samples.

In an example embodiment, the first instance of a pretrained LLM and the second instance of a pretrained LLM, are based on GPT-4 or BERT.

Optionally, the quality of the expanded dataset can be manually tested via an interface by human reviewers (e.g., expert supervision) that, through the interface of user device 100, can execute a ground truth validation operation 516 to check the generated samples and their labels to verify that the first instance of the pretrained LLM and/or second instance of the pretrained LLM have correctly understood and applied the labeling rules. Mistakes it may have made can also be corrected via the interface of user device 100. This validation step helps maintain the integrity of the dataset, ensuring it is accurate and reliable for further use.

In some embodiments, a combining operation performs combining the initial known dataset D, the expanded queries dataset Q′ which includes generated and validated samples, and the augmented data from augment operation 510, to create the augmented synthetic dataset Q″ 507. The augmented synthetic dataset Q″ 507 now contains a wide variety of examples with accurately labeled entities, providing a rich resource for training a model.

In some embodiments, the augmented synthetic dataset Q″ is used to train an NER model 550. The NER model 550 is designed to identify and classify entities within text based on the labels in the training set (i.e., augmented synthetic dataset Q″ 507). The training process involves teaching the NER model 550 to recognize patterns and features associated with different entities, improving its ability to accurately label new, unseen text.

In some embodiments, the NER model 550 is trained using backpropagation with a loss function 554. The training data for the NER model 550 includes input texts and their corresponding true labels. During training, the NER model 550 processes the input text and generates predicted labels as NER output 552. These predicted labels are probabilities indicating how likely each token belongs to each possible class. A loss function 554 measures the discrepancy between the NER output 552 (e.g., predicted labels) and the true labels. In some embodiments, the loss function implements cross-entropy loss to calculates the negative log likelihood of the true labels given the predicted probabilities. In some embodiments, the loss function implements Conditional Random Fields (CRF) loss to capture dependencies between labels, where a CRF layer adjusts the predicted probabilities to ensure valid sequences and computes the loss based on the entire sequence rather than individual tokens.

Once the loss is calculated, it is used to update the NER model's parameters through backpropagation. The gradients of the loss function with respect to the model parameters are computed, and the model parameters are adjusted to minimize the loss.

This process of predicting labels, computing the loss, and updating the model parameters is repeated iteratively over many epochs and batches of training data. Over time, the model learns to produce more accurate label predictions.

While the above process 500 illustrates a pipeline using the NER model 550 as a “main” block to convert text into the structured format, alternative implementations may be used. For instance, there may be a variant of fine-tuning a pretrained generative LLM into generating the structured out (e.g., JSON or another structured format) from text. Thus, there may be an alternative whereby (e.g., instead of blocks 550 and 552), there is instead a pre-trained generative LLM. For instance, the LLM may be trained to recognize output targets from the input samples, such as creating a structured format from a given input. The model can also be trained using a loss function which, given an input, compares the predicted output with the expected output and trains, fine-tunes, or otherwise modifies the model accordingly.

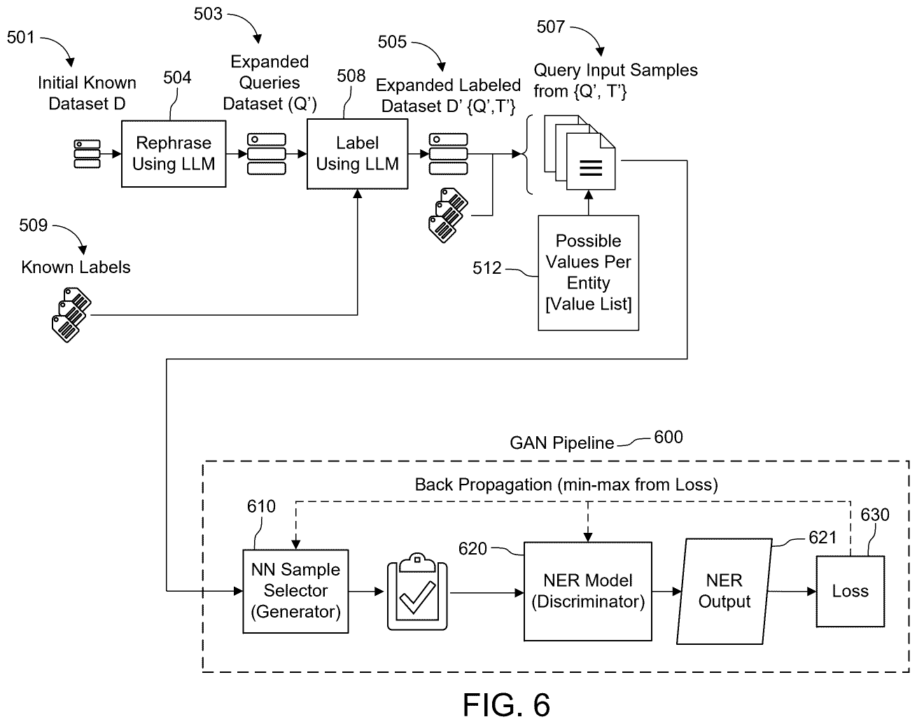

Instead of generating an augmented synthetic dataset {Q″, T″} as described above, new samples can be generated directly using a Generative Adversarial Approach (GAN). FIG. 6 shows a GAN pipeline 600 in which a generator 610 operates as a sample selector among a previously generated dataset, according to an example embodiment. In an example implementation, the previously generated dataset is the expanded labeled dataset D′ discussed above with respect to data generation process 500 depicted in FIG. 5. Particularly, expanded labeled dataset D′ is defined as the aggregation of the rephrased versions of the input samples Q′ and their corresponding labeled versions T′, represented as {Q′,T′}.

D′ is generated as follows. An initial known dataset 501 (D) includes samples of the text, along with corresponding known labels 509, is received. In turn, a rephrasing operation 504 performs rephrasing the initial known dataset 501 using a first instance of an LLM to produce an expanded queries dataset Q′ of the initial known dataset samples qᵢ according to a rephrasing process (e.g., in-context LLM training process 222, fine-tune generative LLM process 224, or random parameter training process 226 described above in connection with FIG. 2).

In turn, labeling operation 508 applies a second instance of the pre-trained LLM to identify and label all the entity references in the rephrased versions of the input samples Q′ using known labels 509 or placeholders such that labeled dataset T′=f(qᵢ∈Q′), where labeled dataset T′ 505 represents the output, which is a labeled version of the rephrased versions Q′ of the input samples qᵢ, as explained above.

In this embodiment, instead of generating new samples directly, generator 610 in the GAN pipeline 600 uses a neural network to select particular samples from queries of dataset Q′ 507 along with possible values. The generator 610 generates samples by selecting particular samples from queries of dataset Q′ 507, where the queries of dataset Q′ are referred to as query input samples Q′ 507. The selected query input samples Q′ along with the corresponding entity 512 are fed into an NER model 620 to train the NER model 620.

The input sample representation that is input to the GAN pipeline 600 may be represented as a query that is formatted in different ways. In an example implementation, the query is formatted as plain text. Particularly the query is provided directly as a string of text. For example, “Find the capital of France” could be a plain text query.

In another example implementation, the query is represented as an identifier within a query dataset. Instead of using the actual text, a reference or index is used to point to a specific query in a pre-defined dataset. For example, instead of the text “Find the capital of France,” an identifier like “Q12345” corresponding to this query in the dataset is provided.

In addition to the query (whether in plain text or as an identifier), each input sample can include a selected value per each entity. This means that for each entity within the query, there is a corresponding value that has been chosen. An entity could be a named entity like a person, location, organization, etc.

The selection process, performed by generator 610 can be based on various criteria, such as quality, relevance, or specific characteristics that make the selected samples suitable for the task at hand.

In a typical GAN setup, a generator creates new data instances to fool a discriminator into believing they are real. However, in this modified GAN pipeline 600, the task of generator 610 is adapted to selecting the best-fitting samples from an existing pool of synthetic data, potentially streamlining the process and leveraging the pre-generated data's quality.

In an example embodiment, GAN pipeline 600 dynamically selects samples from a pool of potential combinations. The dynamically selected samples are used to train an NER model. The generator 610 of the GAN generates relatively high-quality and diverse samples. An NER model 620 operating as a discriminator, in turn, identifies the most representative and useful samples for training the models. By using a GAN-based approach, these embodiments aim to optimize the selection of samples from the pool of potential combinations, ensuring that the training process is more efficient and effective. This leads to improved model performance and better utilization of computational resources. The structure of a GAN pipeline 600 can be constructed in different ways.

In some embodiments, a loss function 630 is utilized to optimize both the generator 610 and the discriminator 620 through backpropagation in a min-max scenario. In this example the GAN pipeline 600 includes the generator 610, which creates synthetic data samples, and the discriminator 620, which evaluates the authenticity of these samples, distinguishing between real and generated data. The training process involves a minimax game where the generator 610 and discriminator 620 have opposing objectives.

The discriminator's loss function measures its ability to correctly identify real samples and misclassify generated samples. It aims to maximize the probability of correctly identifying real data and minimize the probability of classifying generated data as fake. On the other hand, the generator's loss function measures its success in producing samples that fool the discriminator 620. It aims to maximize the probability that the discriminator 620 classifies generated samples as real.

This dynamic and iterative learning process helps both the generator 610 and the discriminator 620 improve over time, ultimately enhancing the quality of the generated data.

In some embodiments, the neural network is trained in an adversarial manner relative to the final model. The adversarial training involves training the network to compete against the final model, aiming to generate samples that are more challenging for the final model to classify accurately. To achieve this, the neural network is trained through backpropagation using the inverse loss function 630 of the discriminator 620. The inverse loss function is the opposite of the loss function used to train the discriminator 620. By optimizing the neural network with respect to this inverse loss function, it learns to generate samples that are more difficult for the discriminator to correctly classify. This process enhances the quality and diversity of the generated samples, leading to improved training and performance of the final model.

In some embodiments, a selection model is used to select samples from the generated set. Each sample is represented by an identifier for a query sample (qᵢ″) and one value for each entity. In an example implementation, the selection model is a neural network.

In some embodiments, a combination of language modules can be used to ingest the query sample (qᵢ″) along with the values for each entity. This combination of language modules is used to help in generating various combinations of queries (q) and entity values.

In an example embodiment, the synthetic generator is supplied a randomly chosen combination of queries (q) and the corresponding values for each entity. The synthetic generator, in turn, selects one sample input from this combination for training the discriminator model.

The random selection procedure employed by the synthetic generator prevents potential infinite loops that may occur if the selector were used to pick one sample from all possible options. Without the random selection, there is a risk of continuously choosing the same samples, leading to redundant training and potentially biased results.

By incorporating the random selection process, the synthetic generator ensures diversity in the samples chosen for training the discriminator, enhancing the effectiveness and efficiency of the overall training process.

In turn, an LLM is trained to recognize the output targets from the input samples. This task can be approached from a generative perspective, where the model is tasked with creating a structured format (e.g., JSON or any pre-defined structure) from a given input. The model can also be trained using a loss function which, given an input, compares the predicted output \hat{t} with the expected t.

Generally, the embodiments described herein can be used to create a pipeline that is able to understand queries explained in natural language and to provide the results of such query to the user. Via instruction tuning and a few examples, a pre-trained LLM is applied to convert text corresponding to a query into a predefined JSON format that contains the entities and values expressed by the user input. In turn, the input in JSON format is fed to an actual query engine that converts the information in an actual query to the DB, and returns the output to the user.

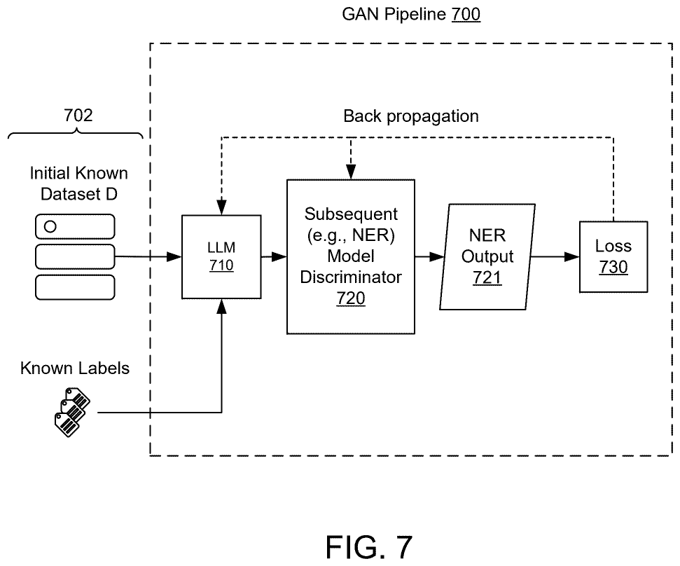

FIG. 7 illustrates a Generative Adversarial Network (GAN) pipeline 700 for enhancing a training dataset and model performance for a Named Entity Recognition (NER) model, according to an example embodiment. Generally, a GAN pipeline is a type of machine learning model that consists of a synthetic generator and a discriminator. The synthetic generator creates samples, while the discriminator evaluates and distinguishes between real and generated samples.

A pre-trained LLM can be integrated within the GAN pipeline 700, as displayed in FIG. 7. In an example embodiment, the LLM is fine-tuned utilizing an inverse loss function 730 of a subsequent model 720 that is used to generate subsequent model output 721 (e.g., NER output). This results in generating relatively more challenging and effective training samples. This integration leverages the advanced language understanding and generation capabilities of the LLM.

In an example embodiment, a generator produces synthetic text samples 702 that resemble the initial known dataset D, complete with appropriate entity labels.

The inverse loss function 730 is essentially the opposite of a loss function used in training a subsequent model 720 (e.g., NER model). The objective is to generate more challenging and effective training samples for the subsequent model. By fine-tuning an LLM 710 with the inverse loss function 730, the LLM 710 is encouraged to generate samples that are more difficult for the subsequent model 720 to handle. This adds complexity and diversity to the training data, enabling the subsequent model to learn from more challenging examples. Integrating the LLM in this way within the GAN pipeline enhances the data generation process and can improve the overall training performance and generalization of the subsequent model.

As explained above, in the context of NLP, an NER involves identifying and classifying entities within a text, where the NER model is a sequence tagging model that assigns a label to each token in a sentence, indicating whether it is part of an entity and what type of entity it is.

In some examples, the NER system is not a traditional “discriminator” in a GAN but performs a similar evaluative role within the GAN pipeline. For instance, in a GAN pipeline designed for text generation, the generator creates text samples, while a discriminator traditionally evaluates the realism of the generated text. Instead of a traditional discriminator, an NER might be used to ensure that the generated text contains coherent and contextually appropriate named entities. Here, the NER helps evaluate the quality of the generated text by checking whether the named entities are correctly identified and appropriately used, similar to how a discriminator would assess the authenticity of the content.

In another example, where a GAN setup is focused on improving named entity recognition models, the generator might create synthetic text samples with entities, and the NER can act in a role similar to a discriminator by evaluating how well these synthetic entities match expected patterns. For example, the NER system might assess whether generated texts contain plausible named entities and whether these entities align with the typical distribution observed in real-world data. This evaluation helps guide the generator to produce more realistic and contextually appropriate named entities.

A discriminator is a component of a GAN that distinguishes between real and generated data. In some embodiments, a discriminator is used to evaluate the quality of entity recognition performed by an NER model. In other words, in some embodiments, the GAN pipeline 700 includes a discriminator that is the NER model. Its role is to evaluate the authenticity of the generated text samples, distinguishing between real samples from the training data and synthetic samples produced by the generator. The discriminator assigns a loss value based on its confidence in the authenticity of the samples. A lower loss indicates that the sample is more indistinguishable from real data. In some embodiments, the GAN pipeline employs backpropagation of the inverse loss function from the discriminator to the generator. This process involves assessing by the discriminator (e.g., the NER model) the generated samples and calculating a loss, reflecting the degree to which the samples are recognized as synthetic. An inverse of this loss function is then propagated back through the GAN pipeline to the generator within the LLM. This inverse loss provides a gradient that indicates how the generator's parameters should be adjusted to produce more realistic samples in the next iteration.

In turn, the generator within the LLM is updated either by modifying its internal parameters or by adjusting its prompting strategies. These updates are guided by the inverse loss gradients received from the discriminator.

In some embodiments, parameter updates involve fine-tuning the weights and biases within the LLM to enhance its text generation capabilities. Prompting updates involve altering the initial input prompts or conditions provided to the LLM to steer the generation process more effectively.

In some embodiments, the GAN pipeline operates in an iterative cycle where the generator produces new samples, the discriminator evaluates them, and the feedback loop updates the generator. This cycle continues until the generated samples become highly indistinguishable from real data. Each iteration enhances the quality and realism of the synthetic samples, thereby improving the training dataset's overall quality. The final output of this GAN pipeline is a large, high-quality labeled dataset comprising both original and highly realistic synthetic samples. This enriched dataset is then used to train the NER model, significantly enhancing its ability to recognize and classify entities within text accurately.

### Computing Environment

FIG. 8 discloses a computing environment 800 in which aspects of the present disclosure may be implemented. A computing environment 800 is a set of one or more virtual or physical computers 810 that individually or in cooperation achieve tasks, such as implementing one or more aspects described herein. The computers 810 have components that cooperate to cause output based on input. Example computers 810 include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 800 includes at least one physical computer.

The computing environment 800 may specifically be used to implement one or more aspects described herein. In some examples, one or more of the computers 810 may be implemented as a user device, such as mobile device and others of the computers 810 may be used to implement aspects of a machine learning framework useable to train and deploy models exposed to the mobile device or provide other functionality, such as through exposed application programming interfaces.

The computing environment 800 can be arranged in any of a variety of ways. The computers 810 can be local to or remote from other computers 810 of the computing environment 800. The computing environment 800 can include computers 810 arranged according to client-server models, peer-to-peer models, edge computing models, other models, or combinations thereof.

In many examples, the computers 810 are communicatively coupled with devices internal or external to the computing environment 800 via a network 190. The network 190 is a set of devices that facilitate communication from a sender to a destination, such as by implementing communication protocols. Example networks 190 include local area networks, wide area networks, intranets, or the Internet.

In some implementations, computers 810 can be general-purpose computing devices (e.g., consumer computing devices). In some instances, via hardware or software configuration, computers 810 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 810 include one or more processors 812, memory 814, and one or more interfaces 818. Such components can be virtual, physical, or combinations thereof.

The one or more processors 812 are components that execute instructions, such as instructions that obtain data, process the data, and provide output based on the processing. The one or more processors 812 often obtain instructions and data stored in the memory 814. The one or more processors 812 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 812 include at least one physical processor implemented as an electrical circuit. Example providers of processors 812 include INTEL, AMD, QUALCOMM, TEXAS INSTRUMENTS, and APPLE.

The memory 814 is a collection of components configured to store instructions 816 and data for later retrieval and use. The instructions 816 can, when executed by the one or more processors 812, cause execution of one or more operations that implement aspects described herein. In many examples, the memory 814 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, transitory memory 814 can store information encoded in transient signals.

The one or more interfaces 818 are components that facilitate receiving input from and providing output to something external to the computer 810, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The one or more interfaces 818 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces 818 can facilitate connection of the computing environment 800 to a network 190.

The computers 810 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Application of Techniques

Techniques herein may be applicable to improving technological processes of a financial institution as will now be described. Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Several investment scenarios, such as swap trades, stock portfolio optimization, equity market index tracking etc., require investors to monitor and adjust their portfolios based on certain attributes or market indexes. The investors often face challenges due to the complex, manual nature of these tasks, and traditional spreadsheet or database tools are often unsuitable due to the dynamic, fast-paced nature of the stock market. One technical challenge involves automating and making user-friendly solutions that can handle data and provide accurate information for effective decision-making.

Practical applications incorporate one or more models into a query engine, where the models have been trained on synthetic data that has been generated by the techniques described above. The query engine is capable of working with natural language text to streamline an investment process. Particularly, instead of relying on complex database commands or spreadsheets, an operator (e.g., an investor) could simply express their query in a human-like, conversational manner. This could be as simple as asking “Show me the stocks with the highest returns over the last month”, “Identify potential bond swaps meeting my investment goals”. Example use-cases of such an engine could be implemented in connection with a financial instrument trading application. For example, swap trades are trades where an investor sells one bond to buy another bond. An investor user engages in a swap trade to sell a bond with a set of attributes and uses the proceeds to purchase a bond with a set of attributes that better achieve the investing clients' objectives.

The following are example queries that can be fed to an application of a model trained as described herein:

“Sell AAPL 5yr bonds, extend <2.25yrs and pick 8bps”
“Sell apple 5year extend 2.25 pic8”

In both case the ask is the same: a desire has been indicated to sell AAPL 5YR benchmark bonds and buy longer maturity bonds that mature no more than two and ¼ years later and are valued a spread that is at least 8 bps higher.

Stock Portfolio Optimization is a process where an investor reallocates their investment in various stocks to maximize returns and minimize risk. The investor user engages in a portfolio optimization to sell stocks with certain attributes and uses the proceeds to purchase stocks with a set of attributes that better meet risk/reward preferences. Currently, stock portfolio optimization is a time-consuming and complex task. Attempting to use Excel spreadsheets or database queries to handle this task can be unwieldy, especially given the huge variety and frequent change in stock market data. Such methods are not practical.

In an example embodiment, a pipeline such as modified GAN pipeline 600 above described in connection with FIG. 6 or GAN pipeline 700 above described in connection with FIG. 7 leverages Large Language Models (LLMs) to build a conversational interface to assist traders, investors, and sales staff with searching the inventory to analyze stock and bond markets.

Referring to FIG. 1, in an example embodiment, a user interface such as the one or more user device interfaces 104 of user device 100 operates to receive a query q to the system 10. In an example use case, q is a plain natural text.

The input q is fed to an LLM, such as GPT3.5 or Llama2 or any other generative language model. In an example implementation, synthetic generator 160 of server 150 incorporates the pre-trained LLM.

In an example embodiment, the LLM is used to generate a functional representation (i.e., formatted version) q^{f} of the entities and related values expressed by the used in the input q. In some embodiments, the JSON format is utilized as the output of the LLM. The model need not be fine-tuned or trained for this specific use-case. Instead, the LLM can be implemented without any additional dataset and environment to train the LLM for the specific use-case and independently to the specific list of entities and values.

In an example embodiment, an instruction-tuning technique is applied to the LLM, where within the prompt itself instructs the LLM on what and how to extract in the formatted output, with a few examples of the desired behavior given within the input.

Some embodiments may use a prompt template that is used to generate the formatted version q^{f}, together with: a list of possible entities that might be retrieved. This might be the list of possible columns of the DB to query, a list of examples of query and related formatted representation, and the actual input q.

An example of such a prompt template may be:
“Act as a trading expert who must extract structured Information from sentences. Read the sentences from the user and extract a one line for each entity as in the examples below. If one or more entities are not specified from the user, use a “null” value. The expected entities are: {entities} Examples: {examples} User: {query} Entities:”

Some embodiments may use a post-generation function to check the correctness of the generated formatted query and to match eventual misspelling either coming from the actual input q, or from the LLM's output q^{f} to match with the specific entities or their possible values, if available. For instance, a misspelled ticker may be automatically converted to its correct version. An example is that a misspelled “AAPL” ticker as “APPL” may be converted to its actual value “AAPL”. Similarly, a ticker expressed with its company name can be matched to its actual ticker of the DB, for example “apple” may be linked to its ticker “AAPL”. Some embodiments may use Levenshtein Distance to find the closest entry of the DB to each entity represented in q^{f}.

Finally, a query engine is used to convert the formatted input q^{f} into the actual query language of the DB, for example mySQL, or python pandas function, or excel functions, etc.

It should be understood that the technologies described herein can be used in various industry-specific applications, including those that require precise and complex data processing. For example, the technology can be used to transactions in real-time to detect patterns indicative of fraudulent activity. By rephrasing and labeling transaction descriptions, the model can learn to identify subtle cues of fraud that may be missed by traditional rule-based systems. This application can thus be used to improve the security and reliability of the systems in which it is incorporated.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for generating a training dataset for training a model, comprising:
receiving a set of input samples;
performing a rephrasing operation to produce new versions of the set of input samples, wherein the new versions preserve semantic equivalence as the set of input samples but have different phrasing;
generating a dataset of generated versions of the input samples using a generative Language Learning Model (LLM);
labeling all entity references present in the generated versions of the input samples; and
aggregating the generated versions of the input samples and their corresponding labeled versions to form an expanded labeled dataset.

2. The method of claim 1, wherein the rephrasing operation includes training a generative LLM in-context by providing the LLM with a prompt that instructs the LLM to create rephrased versions of a target sample.

3. The method of claim 1, wherein the rephrasing operation includes training a generative LLM in-context to produce multiple rephrased versions of a single input sentence.

4. The method of claim 1, wherein the rephrasing operation includes generating a modified version of an input sample by applying a random noise based on a random parameter.

5. The method of claim 1, wherein the rephrasing operation includes generating a modified version of an input sample by applying a rephrasing function based on a random parameter.

6. The method of claim 1, further comprising:
applying a function to the generated versions of the input samples and corresponding placeholders for entity values, where the function replaces the corresponding placeholders with a list of potential values.

7. The method of claim 6, wherein the function replaces the corresponding placeholders with actual values for a list of potential values for each entity.

8. The method of claim 1, wherein the expanded labeled dataset is used to train models in text-to-structured tasks.

9. The method of claim 1, further comprising:
converting a text-based query into an executable database query by:
receiving a text-based query;
interpreting the text-based query using a pre-trained Named Entity Recognition (NER) model to classify entities within the query thereby generating identified entities, wherein the NER model is trained on the expanded labeled dataset;
converting the identified entities into a predetermined standardized format to create a structured representation of the text-based query;
mapping the structured representation to a query format compatible with a target database to generate an executable query;
executing the executable query on the target database to perform a requested search or transaction; and
communicating a response from the target database back to a user device for presentation to a user.

10. The method of claim 9, wherein the text-based query is tokenized into tokens, and the NER model tags each token with corresponding entity labels.

11. The method of claim 9, wherein the NER model classifies the identified entities into respective categories based on labels used during training of the NER model.

12. The method of claim 1, further comprising:
receiving the expanded labeled dataset, wherein the expanded labeled dataset comprises rephrased versions of the set of input samples;
using a generator in a Generative Adversarial Network (GAN) pipeline to select particular samples from the rephrased versions of the set of input samples, thereby generating selected samples; and
feeding the selected samples along with corresponding entity values into a Named Entity Recognition (NER) model to train the NER model.

13. The method of claim 12, further comprising:
optimizing the generator and the NER model through backpropagation using a loss function;
converting, using the trained NER model, a text-based query into a structured format by identifying and classifying entities within the text-based query;
mapping the structured representation of the query to a query format compatible with a target database; and
executing the mapped query on the target database to perform a requested search or transaction.

14. The method of claim 12, further comprising:
evaluating the authenticity of the selected samples, using a discriminator of the GAN pipeline, by distinguishing between real and generated data.

15. The method of claim 12, wherein the structured format of the query includes representing each identified entity as a key-value pair.

16. The method of claim 1, further comprising:
generating synthetic text samples using a generator within a Generative Adversarial Network (GAN) pipeline;
fine-tuning, using a pre-trained Language Learning Model (LLM) within the GAN pipeline the LLM with an inverse loss function of a subsequent model used to generate subsequent model output, the fine-tuning causing the LLM to generate more training samples for the subsequent model;
evaluating a quality of entity recognition performed by the subsequent model using a discriminator, wherein the discriminator includes the NER model; and
updating the generator based on the evaluation of the generated samples by the discriminator, the updating involving modifying internal parameters or changing a prompt to produce alternative samples.

17. The method of claim 16, further comprising:
generating, using the pre-trained LLM, synthetic text samples that resemble the initial known dataset by fine-tuning the weights and biases within the LLM causing a change in a prompt.

18. The method of claim 16, wherein the inverse loss function is propagated back through the GAN pipeline to the generator, providing a gradient indicating parameters of the generator to be adjusted.

19. The method of claim 16, wherein the GAN pipeline includes an iterative cycle of generating new samples, evaluating them using the discriminator, and updating the generator based on the evaluation.

20. A system for generating a training dataset for training a model, comprising:
a processor;
a memory operatively connected to the processor and storing instructions which, when executed by the processor, cause the system to perform:
receiving a set of input samples;
performing a rephrasing operation to produce new versions of the set of input samples, wherein the new versions preserve semantic equivalence as the set of input samples but have different phrasing;
generating a dataset of generated versions of the input samples using a generative Language Learning Model (LLM);
labeling all entity references present in the generated versions of the input samples; and
aggregating the generated versions of the input samples and their corresponding labeled versions to form an expanded labeled dataset.
